(19) United States
(12) Patent Application Publication
(10) Pub. No.: US 2022/0318655 A1
(43) Pub. Date: Oct. 6, 2022

(54) METHOD OF PROVIDING ARTIFICIAL INTELLIGENCE SERVICE BASED ON USER PARTICIPATION AND APPARATUS FOR PERFORMING THE SAME

(71) Applicant: OMNIS LABS COMPANY, Seoul (KR)

(72) Inventor: Gwi Hwan MOON, Seoul (KR)

(21) Appl. No.: 17/597,544

(22) PCT Filed: Oct. 8, 2021
(86) PCT No.: PCT/KR2021/013859

§ 371 Date: Jan. 11, 2022

(30) Foreign Application Priority Data
Nov. 10, 2020 (KR) 10-2020-149222

(51) Int. Cl. G06N 5/04; G06Q 10/06

(52) U.S. Cl. CPC G06N 5/04; G06Q 10/063

(57) ABSTRACT

A method of providing an artificial intelligence service based on user participation and an apparatus for performing the same. The method of providing an artificial intelligence service based on user participation may include receiving, by an artificial intelligence service platform, a request for an artificial intelligence service from a user device, receiving, by the artificial intelligence service platform, user-provided data from the user device, and providing, by the artificial intelligence service platform, the artificial intelligence service to the user device based on the user-provided data.

### BACKGROUND

### 1. Field of the Invention

The present invention relates to a method of providing an artificial intelligence service based on user participation and an apparatus for performing the same. More particularly, the present invention relates to a method and apparatus for effectively providing an artificial intelligence service to a user through a project created by a user.

### 2. Discussion of Related Art

Recently, deep learning has been used in various fields such as speech recognition, natural language processing, and big data analysis without being limited to image recognition. For example, image recognition using deep learning has been applied and used from simple classification problems to relatively difficult problems such as face detection and behavior prediction. In deep learning, networks with several structures are used. Typically, a convolutional neural network (CNN) is used for deep learning. However, designing an accurate and effective network for deep learning requires a lot of experience, and non-experts may have difficulties designing artificial intelligence models such as deep learning networks. Therefore, there is a need for research on a platform for general users, not professional artificial intelligence developers, to more easily utilize artificial intelligence models.

### SUMMARY OF THE INVENTION

An object of the present invention is to solve all of the above problems.

In addition, the present invention is to provide an artificial intelligence service platform for a user to easily utilize an artificial intelligence model.

In addition, the present invention is to facilitate user's artificial intelligence model learning through an artificial intelligence service platform, and input data processing through a user's pre-designed artificial intelligence model.

In addition, the present invention is to provide an artificial intelligence service for multiple users to participate in one artificial intelligence project and to target multiple users.

A representative configuration of the present invention for achieving the above object is as follows.

According to an embodiment of the present invention, a method of providing an artificial intelligence service based on user participation may include receiving, by an artificial intelligence service platform, a request for an artificial intelligence service from a user device, receiving, by the artificial intelligence service platform, user-provided data from the user device, and providing, by the artificial intelligence service platform, the artificial intelligence service to the user device based on the user-provided data.

The artificial intelligence service platform may include one or more artificial intelligence applications for the artificial intelligence service, and each of the one or more artificial intelligence applications may be created based on an artificial intelligence model.

The artificial intelligence ser7vice platform may create a project corresponding to the user device for the artificial intelligence service, and the user-provided data may be stored in correspondence to the project.

An artificial intelligence service platform for providing an artificial intelligence service based on user participation may include: a master server configured to receive a request for an artificial intelligence service from a user device, a storage server configured to receive user-provided data from the user device, and a worker server configured to provide the artificial intelligence service to the user device based on the user-provided data.

The artificial intelligence service platform may include one or more artificial intelligence applications for the artificial intelligence service, and each of the one or more artificial intelligence applications may be created based on an artificial intelligence model.

The storage server may create a project corresponding to the user device for the artificial intelligence service, and the user-provided data may be stored in correspondence to the project.

### BRIEF DESCRIPTION OF THE DRAWINGS

FIG. 1 is a conceptual diagram illustrating an artificial intelligence service platform according to an embodiment of the present invention.

FIG. 2 is a conceptual diagram illustrating an operation of a master server according to an embodiment of the present invention.

FIG. 3 is a conceptual diagram illustrating a worker server according to an embodiment of the present invention.

FIG. 4 is a conceptual diagram illustrating a storage server according to an embodiment of the present invention.

FIG. 5 is a conceptual diagram illustrating a method of providing an artificial intelligence service to a user device according to an embodiment of the present invention.

FIG. 6 is a conceptual diagram illustrating a method of providing an artificial intelligence service to a user device according to an embodiment of the present invention.

FIG. 7 is a conceptual diagram illustrating a project setting method according to an embodiment of the present invention.

FIG. 8 is a conceptual diagram illustrating a method of providing an artificial intelligence service according to an embodiment of the present invention.

FIG. 9 is a conceptual diagram illustrating a method of providing an artificial intelligence service according to an embodiment of the present invention.

### DETAILED DESCRIPTION OF EXEMPLARY EMBODIMENTS

The detailed description of the present invention set forth below is made with reference to the accompanying drawings, which show by way of illustration specific embodiments in which the invention may be practiced. These embodiments will be described in detail for those skilled in the art in order to practice the present invention. It should be appreciated that various exemplary embodiments of the present invention are different from each other, but need not be mutually exclusive. For example, specific shapes, structures, and characteristics described in the present specification may be changed from one embodiment to another embodiment and implemented without departing from the spirit and the scope of the present invention. In addition, it should be understood that a position or an arrangement of individual components in each disclosed embodiment may be changed without departing from the spirit and the scope of the present invention. Accordingly, the detailed description set forth below is not to be taken in a limiting sense, and the scope of the present invention should be taken as encompassing the scope of the claims and all equivalents thereto. In the drawings, like reference numerals refer to the same or similar elements throughout the various aspects.

Hereinafter, various preferred embodiments of the present invention will be described in detail with reference to the accompanying drawings so that those skilled in the art to which the present pertains may easily practice the present invention.

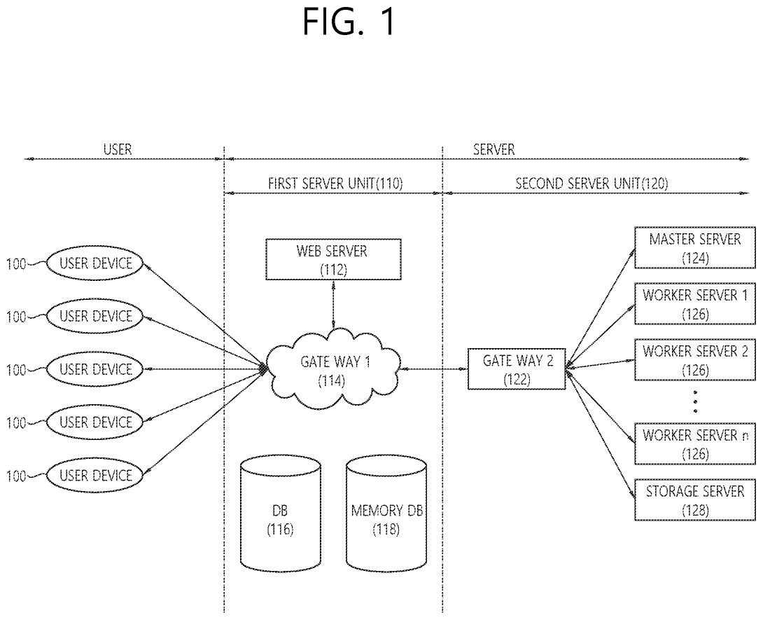

FIG. 1 is a conceptual diagram illustrating an artificial intelligence service platform according to an embodiment of the present invention.

FIG. 1 discloses an artificial intelligence service platform that provides an artificial intelligence service to a user.

Referring to FIG. 1, the artificial intelligence service platform may include a user device 100, a first server unit 110, and a second server unit 120. For convenience of description, the first server unit 110 and the second server unit 120 are separately described according to functions, but conceptually, may be viewed as one server. Such an embodiment may also be included in the scope of the present invention. In addition, the first server unit 110 and the second server unit 120 may be implemented as a cloud server, but the first server unit 110 and the second server unit 120 are not limited to the cloud server and may be implemented as various types of servers. Such an embodiment may also be included in the scope of the present invention.

The user device 100 may be provided with an artificial intelligence service (e.g., an artificial intelligence application) on the artificial intelligence service platform. The artificial intelligence service platform may provide artificial intelligence services based on each of the plurality of artificial intelligence applications to the user device 100. The artificial intelligence application may be an artificial intelligence model for image segmentation, facial expression recognition, image style transfer, face detection, pedestrian detection, face comparison, or the like in the field of object detection.

The artificial intelligence model may include a pre-trained artificial intelligence model, an artificial intelligence model that has not been trained, and the like. The pre-trained artificial intelligence model may be expressed in terms of an artificial intelligence model (training completed), and an untrained artificial intelligence model may be expressed in terms of an artificial intelligence model (training not completed).

For example, the user device 100 may select the artificial intelligence model (training completed) provided on the artificial intelligence service platform, input user-provided data (first type) for training on the artificial intelligence model (training not completed) to create the artificial intelligence model (training not completed) as the artificial intelligence model (training completed), and output artificial intelligence processing data (first type) during the operation. After the creation of the artificial intelligence model (training completed), user-provided data (second type) to be processed through the artificial intelligence model (training completed) may be input. The artificial intelligence processing data (second type) according to the user-provided data (second type) may be output through the artificial intelligence model (training completed).

As another example, without a separate training process, the user device 100 may select the artificial intelligence model (training completed) provided on the artificial intelligence service platform, and input the user-provided data (second type) on the artificial intelligence model (training completed). The artificial intelligence processing data (second type) according to the user-provided data (second type) may be output through the artificial intelligence model (training completed).

The user-provided data (first type) is training data input through the user device 100. The artificial intelligence processing data (first type) is data including information on the training process of the artificial intelligence model of the second server unit 120.

The user-provided data (second type) is data to be processed through a pre-created artificial intelligence model (training completed) input through the user device 100. The artificial intelligence processing data (second type) is data including information on the processing of the user-provided data (second type) of the artificial intelligence model of the second server unit 120.

In addition, the user device 100 may change the design of the artificial intelligence model provided on the artificial intelligence service platform. In the user device, user-provided data (third type) is data for a change in design of the artificial intelligence model input through the user device 100. The artificial intelligence processing data (third type) is data including information on the artificial intelligence model that is designed and changed on the second server unit 120 based on the user-provided data (third type).

A detailed operation between the user device 100 and the server unit (the first server unit 110 and the second server unit 120) will be described below.

The first server unit 110 may be implemented for user authentication and user data management. For example, the first server unit 110 may be a cloud server.

The first server unit 110 may include a web server 112, a database (DB) 116, a memory database (DB) 118, and a gateway 1 114.

The web server 112 is a server that transmits login and authentication, payment, and html assets of the user device 100.

The DB 116 is a database for storing information to be recorded, such as user information, payment details, and project information.

The memory DB 118 is a volatile database, and is a database containing information that is temporarily stored, such as socket information of a project, a graphics processing unit (GPU) operation state, and session authentication management of the user device 100.

The gateway 1 114 may operate as a logical gateway that receives a request from the user device 100 and distributes the request to various servers. The gateway 1 114 may be implemented as a switch or a server.

The second server unit 120 may be implemented to provide an artificial intelligence service through an artificial intelligence application. Practical artificial intelligence training may be performed on the second server unit 120. The second server unit 120 may be a GPU-based cloud server.

The second server unit 120 may include a gateway 2 122, a master server 124, a worker server 126, and a storage server 128.

The gateway 2 122 is a gateway located at the top of its own server and may be implemented as a switch or a server.

The master server 124 may perform load balancing according to the GPU usage state of the worker server 126. The master server 124 may be connected to the worker server 126 based on a first communication method and/or a second communication method, and may adaptively communicate with the worker server 126 based on the first communication method and/or the second communication method. The first communication method is a synchronization method and may be used when data synchronization and real-time data processing are required, and the second communication method is an asynchronous communication method and may be used when data synchronization and data real-time processing are not required.

The worker server 126 may be a server that substantially performs artificial intelligence operations (e.g., deep learning). The worker server 126 may be connected to the master server 124 and the storage server 128 based on the first communication method or the second communication method, and adaptively communicate with the master server 124 and the storage server 128 based on the first communication method and/or the second communication method.

The storage server 128 may be implemented to store a project created by the user device 100, user-provided data, artificial intelligence processing data, and the like. The storage server 128 may be connected to the worker server 126 based on the first communication method or the second communication method.

Hereinafter, a specific method of providing an artificial intelligence service is disclosed.

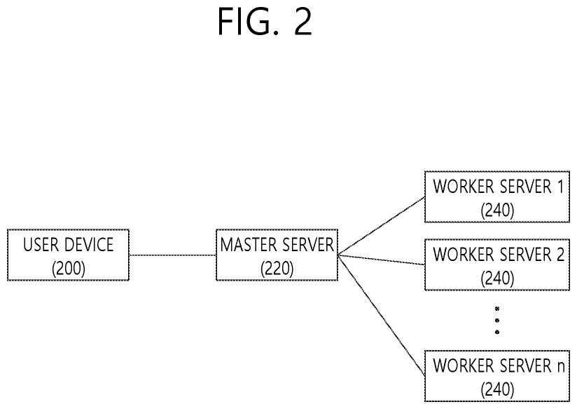

FIG. 2 is a conceptual diagram illustrating an operation of a master server according to an embodiment of the present invention.

The operation of the master server for providing artificial intelligence services is disclosed with reference to FIG. 2.

Referring to FIG. 2, the master server 220 may be implemented for worker server load balancing and migration.

The master server 220 may be connected to at least one worker server 240. The artificial intelligence processing is performed in the worker server 240. There are a plurality of worker servers 240 that perform the artificial intelligence processing, and the number of GPUs of each of the plurality of worker servers 240 is limited. Therefore, it is necessary to efficiently utilize GPU resources by monitoring active GPUs that are operating and inactive GPUs that are not operating. The master server 220 may maintain the always-connected state with the worker server 240 through the first communication method, and perform the worker server load balancing that distributes GPU resources when the user device 200 requests the provision of an artificial intelligence service.

For example, when the user device 200 requests an artificial intelligence service, the artificial intelligence service request may be transmitted to the master server 220. The master server 220 may determine the state of the connected worker server 240, and allocate artificial intelligence processing to the worker server 240 having available GPU resources.

Thereafter, the master server 220 may receive the artificial intelligence processing data including information on the process and/or result of the artificial intelligence processing from the worker server 240, and transmit the artificial intelligence processing data to the user device 200. All artificial intelligence processing data may be stored in a storage server connected to the master server 220 or the worker server 240.

In the case where the artificial intelligence service request is received from the user device when all GPU resources are not available, the master server 220 may store the artificial intelligence service request in a priority queue, and may process the GPU resources in the order of priority when the GPU resources are available.

In addition, the master server 220 may manage the migration for managing the structure of the database.

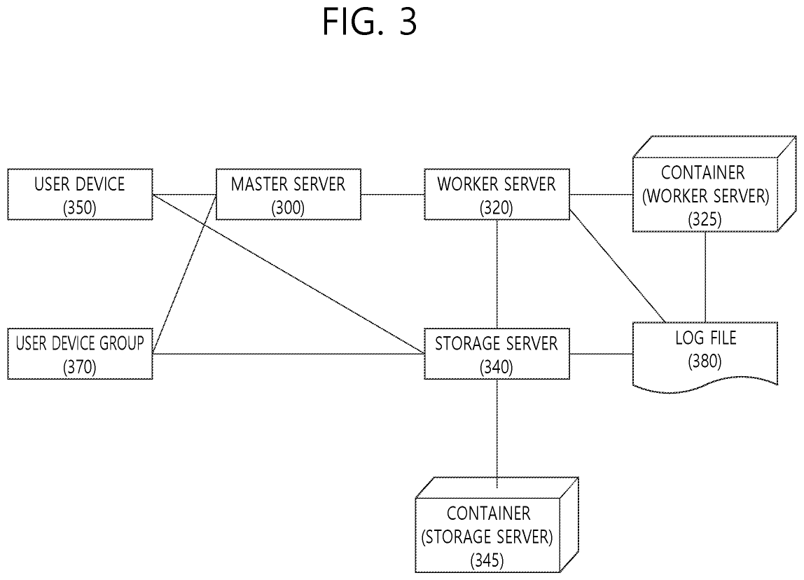

FIG. 3 is a conceptual diagram illustrating a worker server according to an embodiment of the present invention.

The artificial intelligence processing of the worker server is disclosed with reference to FIG. 3.

Referring to FIG. 3, the worker server 320 may perform the artificial intelligence processing according to the request of the user device 350. The project created according to the request of the user device 350 may be performed by being allocated the GPU of at least one worker server 320.

The worker server 320 may receive the artificial intelligence service request from the user device 350 through the master server 300. The worker server 320 may receive project data corresponding to the project of the user device 350 from the storage server 340. The project data may include data generated in connection with the project, such as user-provided data and artificial intelligence processing data. The project created by each user device 350, the user-provided data uploaded by the user device 350, etc. may be stored in the storage server, and the worker server 320 may receive the project data stored in the storage and provide the artificial intelligence services. Grouped user device groups 370 as well as individual user devices 350 may create a project for artificial intelligence services. The project created by the user device group 370 may be stored in the storage server 340, and transmitted to the worker server 320 to perform artificial intelligence processing on the worker server 320.

The artificial intelligence service provided by the worker server 320 may be divided into an artificial intelligence service (active) and an artificial intelligence service (passive) according to type.

The artificial intelligence service (active) may upload training data for training as user-provided data (first type) to train an artificial intelligence model, or upload user-provided data (third type) for a new artificial intelligence model design to design the artificial intelligence model itself.

The artificial intelligence service (passive) may be for processing by uploading user-provided data (second type) for processing to a pre-trained artificial intelligence model.

The user device 350 may directly upload the user-provided data required according to the artificial intelligence service onto the storage server 340, and may preferentially store the uploaded data on the storage server 340 in association with a project.

The worker server 320 may receive the artificial intelligence service request from the master server 300, and copy project data corresponding to the project of the user device stored in the storage server 340. Copying (or transmission) of data between the storage server 340 and the worker server 320 may be performed in units of containers. Specifically, a copy of data between the storage server 340 and the worker server 320 is transmitted to the container (worker server) 325 on the worker server through the container (storage server) 345 on the storage server 340.

The worker server 320 may receive the user-provided data, and create the container (worker server) 325 that is independently executed using the user-provided data and an artificial intelligence service script inside the worker server 320.

After the creation of the container (worker server) 325, the operation (artificial intelligence processing) for the artificial intelligence service may be performed inside the container (worker server) 325, and the artificial intelligence processing data may be recorded in a log file 380. The artificial intelligence processing data may include information on an artificial intelligence service progress state, an artificial intelligence service completion state, the time remaining until the completion of the artificial intelligence service, and the like.

The artificial intelligence processing data may be transmitted from the worker server 320 to the master server 300, and the master server 300 may transmit the artificial intelligence processing data to the user device 350 in real time.

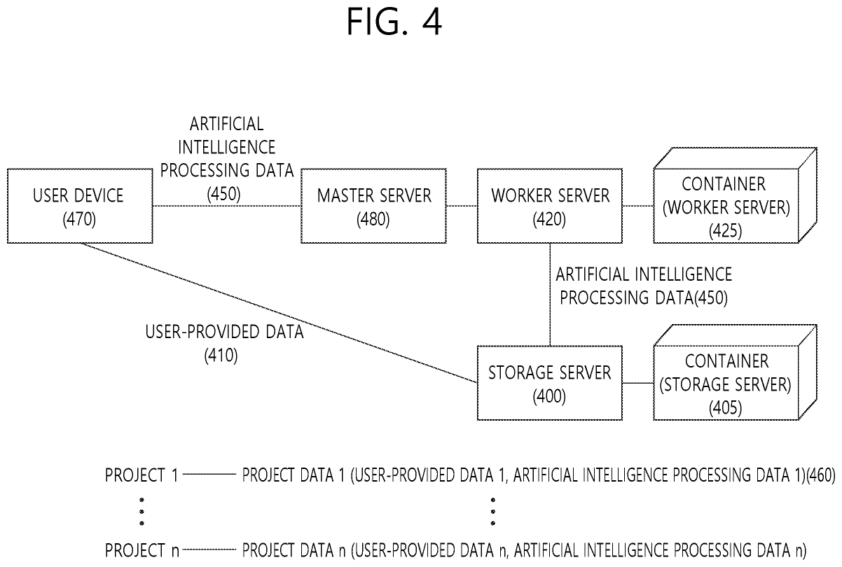

FIG. 4 is a conceptual diagram illustrating a storage server according to an embodiment of the present invention.

Referring to FIG. 4, the storage server 400 may be implemented for management of user-provided data 410 to be used for artificial intelligence processing and management of artificial intelligence processing data 450.

The user-provided data 410 may be classified based on an identifier of a user device 470 and stored on the storage server 400 according to a specific hierarchy.

After the creation of a project of the user device 470, processing before the artificial intelligence processing for the user-provided data 410 within the project may be made on the storage server 400, and prior to the training operation, a project-related application programming interface (API) may be provided by the storage server 400 or the master server. When the user device 470 uses the project-related API, the storage server 400 may manage the user-provided data 410 according to the organized hierarchy. For example, the storage server 400 may perform upload, modification, deletion, storage, and update operations on the user-provided data 410.

As described above, the worker server 420 can perform an actual deep learning operation, and when the worker server requests data related to a specific project, project data (user-provided data, artificial intelligence processing data, etc.) 460 may be transmitted to the worker server 420.

Even in the storage server 400, a separate container (storage server) 405 may be created for the project, and when the worker server 420 requests the project data 460, a project-related container (storage server) 405 may be provided to the worker server 420.

Abstractly, for an artificial intelligence service for a specific project, the storage may transmit the container (storage server) 405 to the worker server 420, and the worker server 420 may perform actual artificial intelligence processing in the container (worker server) 425. The container (storage server) 405 and the container (worker server) 425 may be different in nature.

Specifically, the container (storage server) 405 may be implemented to manage the user-provided data 410 and manage the artificial intelligence processing data 450 generated according to the artificial intelligence processing, and the container (worker server) 425 may be implemented to directly perform the artificial intelligence processing based on the GPU. The artificial intelligence processing data 450 is not only provided to the user device 470 through the master server 480, but also transmitted to the storage server 400. The storage server 400 may store artificial intelligence processing data as project data. The storage server 400 may provide the artificial intelligence processing data received from the worker server 420 to the worker server 420 again at a later time.

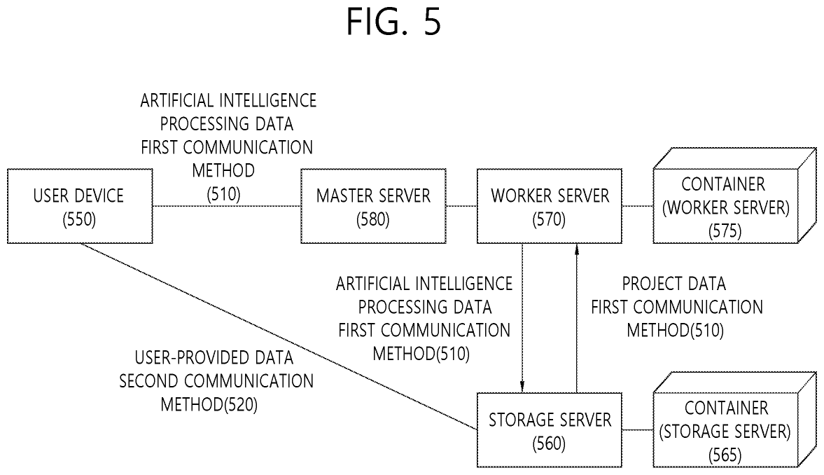

FIG. 5 is a conceptual diagram illustrating a method of providing an artificial intelligence service to a user device according to an embodiment of the present invention.

An artificial intelligence service provided to one user device is disclosed with reference to FIG. 5.

In the present invention, two communication methods (a first communication method and a second communication method) may be used to provide an artificial intelligence service. As described above, the first communication method may be a communication method used in an area in which real-time synchronization is required, and the second communication method may be a communication method used in an area in which real-time synchronization is not required.

Referring to FIG. 5, a user device 550 may create a project on a storage server 560 to receive an artificial intelligence service, and upload user-provided data corresponding to the project. The creation of the project and the upload of the user-provided data corresponding to the project use the second communication method 520, but may be performed through different method access paths. Specifically, the creation of the project may be performed by accessing the storage server 560 through a master server 580, and then, the upload of the user-provided data may be performed by accessing the storage server 560 without directly passing through the master server 580.

The user device 550 may perform additional processing on the user-provided data. For example, when the user-provided data is user-provided data (first type) for training, a preprocessing procedure (e.g., a procedure of identifying an object by surrounding an image by a box) may be performed on the user-provided data. The preprocessing procedure for such user-provided data may also be performed by directly accessing the storage server 560 from the user device based on the second communication method 520 or may be performed through the master server.

The storage server 560 may receive the artificial intelligence processing request of the user device 550 and transmit project data including the user-provided data to a worker server 570 through a container (storage server) 565. The worker server 570 may create a container (worker server) 575 for artificial intelligence processing based on the container (storage server) 565 through a docker engine. The communication between the storage server 560 and the worker server 570 may be the first communication method 510 or the second communication method. The artificial intelligence service platform according to an embodiment of the present invention may use the first communication method 510 for communication between the storage server 560, the worker server 570, the master server, and the user device to transmit the status of artificial intelligence processing to the user device 550 in real time.

The worker server 570 may perform artificial intelligence processing using project data based on the container (worker server) 575. The artificial intelligence processing result may be transmitted to the storage server 560 and the master server 580 as artificial intelligence processing data. The master server 580 may transmit the artificial intelligence processing data to the user device 550.

The artificial intelligence processing requested by the user device 550 may be temporarily suspended and may be performed again by a re-request of the user device 550 later. In this case, the artificial intelligence processing data may be transmitted by synchronizing previous artificial intelligence processing with current artificial intelligence processing. For such synchronization, the artificial intelligence processing data may be recorded in a file immediately after being generated, and transmitted to the master server 580.

When the artificial intelligence processing is suspended, the generated artificial intelligence processing data may be stored in the project of the user device 550 on the storage server 560. Thereafter, when the artificial intelligence processing is performed again, the artificial intelligence processing data is included in the container (storage server) corresponding to the project including the pre-generated artificial intelligence processing data and the user-provided data and transmitted back to the worker server 570 to create the container (worker server) 575, and the container (worker server) 575-based artificial intelligence processing may be performed again.

According to an embodiment of the present invention, the training state (training epoch, training loss, remaining time, etc.) of the deep training model is transmitted to the user in real time based on the first communication method, and the user's training state may be monitored. In order to transmit the real-time training state, the output data of the worker server may be converted to a user format (a format understandable by a user) and stored as the artificial intelligence processing data.

The artificial intelligence processing data may be stored in the master server 580, the worker server, or the storage server. When the training is in progress, the artificial intelligence processing data is periodically read and transmitted to the master server 580, and after the training is finished, the fact that the entire artificial intelligence processing data has been read may be transmitted to the master server 580.

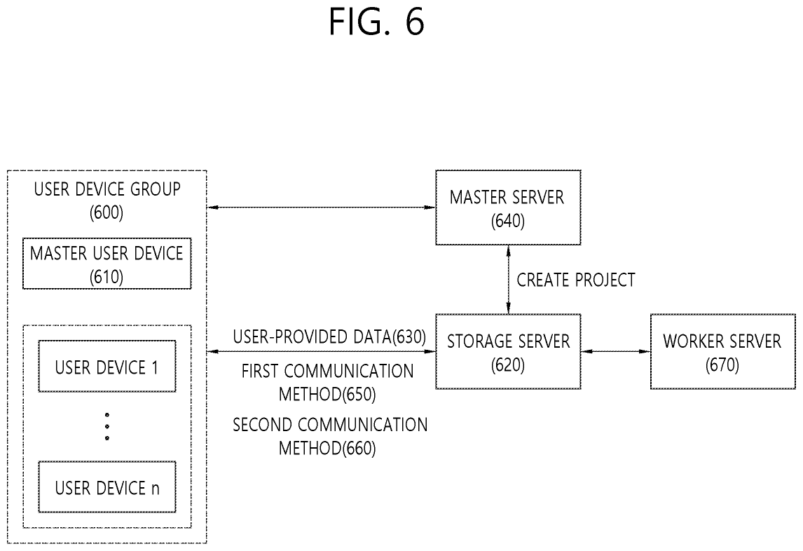

FIG. 6 is a conceptual diagram illustrating a method of providing an artificial intelligence service to a user device according to an embodiment of the present invention. A method for a plurality of user devices to form a user device group and to provide an artificial intelligence service to the user device group is disclosed with reference to FIG. 6.

Referring to FIG. 6, one of a plurality of user devices included in a user device group 600 may create a project as a master user device 610. After the project is created, the right to access the project may be granted to other user devices. The user device group 600 may be formed including the master user device 610 and the user device to which the master user device 610 grants the right to access the project

The plurality of user devices included in the user device group 600 may be granted hierarchical project access rights, and different operations may be performed according to the project access rights. Hereinafter, for convenience of description, a case is disclosed in which separate project access rights are not layered for each user device.

After the master user device 610 creates a project on the storage server to receive the artificial intelligence service, the user device included in the user device group 600 may upload user-provided data 630. Similarly, the creation of the project and the upload of the user-provided data corresponding to the project use a second communication method 660, but may be performed through different method access paths. Specifically, the creation of the project may be performed by accessing a storage server 620 through a master server 640, and then, the upload of the user-provided data 630 may be performed by directly accessing the storage server 620 without passing through the master server 640.

A plurality of user devices included in the user device group 600 may perform additional processing on the user-provided data 630. For example, the plurality of user devices may provide 1,000 cat images as the user-provided data on the project, and perform a data preprocessing procedure to find a cat in the 1,000 cat images and surround the found cat by a box. The preprocessing procedure for the user-provided data 630 may also be performed by directly accessing the storage server 620 from the user device based on the second communication method 660.

According to an embodiment of the present invention, the communication method between the user device and the storage server 620 may be selectively performed with a first communication method 650 or the second communication method 660 according to the nature of data preprocessing.

As described above, when the real-time communication is a preprocessing task to be performed between the user device and the storage server 620, there is a need to share the preprocessing task of the user-provided data 630 through real-time communication between the plurality of user devices included in the user device group 600 and the storage server 620 through the first communication method 650.

On the other hand, when the real-time communication is a preprocessing task that is not required between the user device and the storage server 620, the communication between the plurality of user devices included in the user device group 600 and the storage server 620 may be performed through the second communication method 660.

The communication method may be selectively performed according to whether the preprocessing result for the user-provided data 630 in the user device needs to be synchronized among the plurality of user devices.

Alternatively, when preprocessing overlap, which is a value for determining whether the preprocessing tasks overlap between the plurality of user devices on the artificial intelligence platform, is greater than or equal to a threshold value, the communication method may be adaptively changed, and thus, the preprocessing overlap is less than or equal to the threshold value.

For example, the communication method between the plurality of user devices and the storage server 620 may be set as the second communication method 660 as default setting.

In the case where the preprocessing task of each of multiple users is a task of finding a specific object in an image and surrounding the found specific object by a box and in the case where real-time synchronization fails and multiple users continuously surround the same image by a box occurs redundantly, the preprocessing task may be counted and the preprocessing redundancy is high due to these unnecessary redundant tasks, the processing may be performed by switching the communication method to the first communication method 650 so that the user device does not perform the same preprocessing. When the redundancy is reduced again, the communication method may be switched to the second communication method 660 which is a default communication method.

The storage server 620 may receive an artificial intelligence processing request from a user device (e.g., a master user device 610) having authority included in the user device group 600, and transmit project data including the user-provided data 630 to a worker server 670 through a container (storage server). The worker server 670 may create a container (worker server) for artificial intelligence processing based on the container (storage server) through a docker engine. The communication between the storage server 620, the worker server 670, the master server, and the user device may be a method for real-time synchronization as the first communication method 650.

The worker server 670 may perform the artificial intelligence processing using the project data based on the container (worker server) 575. The artificial intelligence processing result may be transmitted to the storage server 620 and the master server 640 as the artificial intelligence processing data. The master server 640 may transmit the artificial intelligence processing data to the user device 550.

The artificial intelligence processing requested by the authorized user device in the user device group 600 may be temporarily suspended and may be performed again by a re-request of the user device later. Similarly, in this case, the artificial intelligence processing data may be transmitted by synchronizing previous artificial intelligence processing with current artificial intelligence processing. For such synchronization, the artificial intelligence processing data may be recorded in a file immediately after being generated, and transmitted to the master server 640.

In order to transmit the real-time training state, the output data of the worker server may be converted to a user format (a format understandable by a user) and stored as the artificial intelligence processing data. The worker server 670 may store the output data in a log file format when converting the output data or storing the output data as it is.

The artificial intelligence processing data may be stored in the master server 640. When the training is in progress, the artificial intelligence processing data is periodically read and transmitted to the master server 640, and after the training is finished, the fact that the entire artificial intelligence processing data has been read may be transmitted to the master server 640.

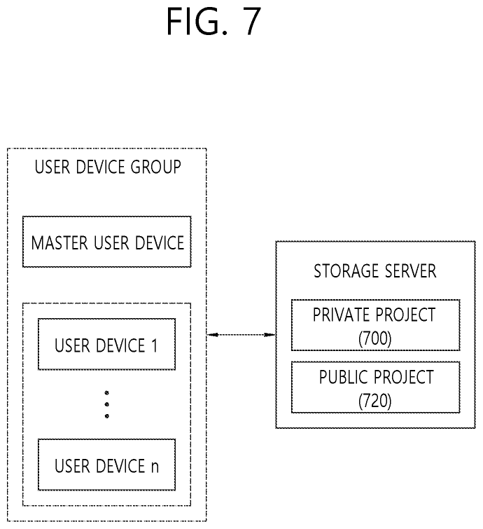

FIG. 7 is a conceptual diagram illustrating a project setting method according to an embodiment of the present invention.

FIG. 7 discloses a method for limiting access rights by setting the nature of a project. Referring to FIG. 7, according to the project setting, the project may be set as a private project 700 or a public project 720 to set different access rights and the like.

Referring to FIG. 7, the private project 700 may be a project in which only a user device that creates a project or is granted the right to access a master user device having specific authority for the project may participate.

The public project 720 may be a project in which a user device to which separate authority is not granted may participate.

For example, in the case of the private project 700, the upload of the user-provided data by the user device and the preprocessing of the user data may be performed only by the user device granted the right to access the project.

The public project 720 may be a project in which the user device to which project authority is not separately granted may participate. For example, when the public project is published on a separate page, anyone may copy the project, and the project may be modified by other users serving as authorized contributors. For example, when a contributor uploads a cat image to a project, an operation of surrounding a cat on the cat image by a box may be performed by multiple contributors. A separate determination algorithm may be applied to the public project 720 to perform an additional verification procedure as to whether the preprocessing of the user-provided data uploaded by the plurality of user devices is correct. In the case of the public project 720, multiple users may participate in the device, and differently from the above, the second communication method between the user device and the storage server may be set as the default communication method, and the second communication method may be switched to the first communication method according to the degree of preprocessing overlap.

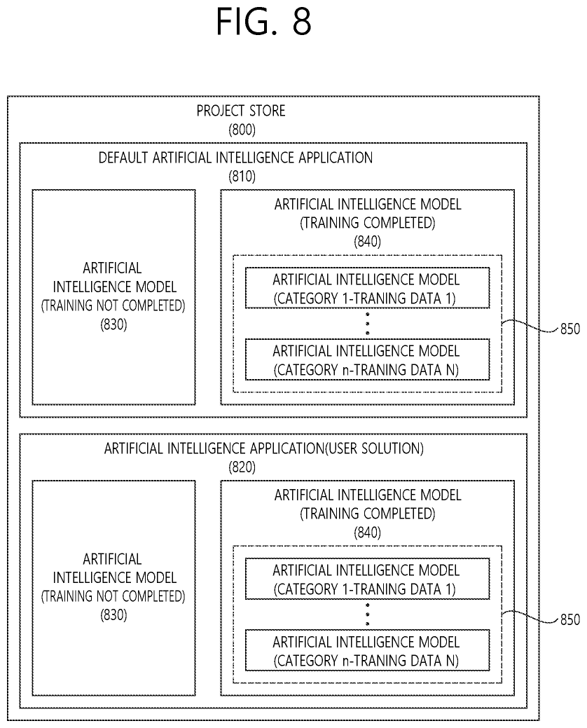

FIG. 8 is a conceptual diagram illustrating a method of providing an artificial intelligence service according to an embodiment of the present invention.

FIG. 8 is a conceptual diagram illustrating a method for utilizing user-provided data related to another project and an artificial intelligence model through a project store. Referring to FIG. 8, the project store 800 may be a default artificial intelligence application 810 provided by itself on the artificial intelligence service platform (e.g., object detection, image segmentation, facial expression recognition, style transfer, face detection, pedestrian detection, face comparison, etc.) as well as may have artificial intelligence applications (user solutions) 820 created by the user device. The artificial intelligence application (user solution) 820 may be an artificial intelligence model separately developed and uploaded by the user device.

The project store 800 may be linked with a worker server, a master server, and/or a storage server. The user device may be provided with a necessary artificial intelligence model on the project store 800. The artificial intelligence model provided on the project store 800 may be provided according to the training state.

The artificial intelligence model provided on the project store 800 may be largely divided into an artificial intelligence model (training not completed) 830 and an artificial intelligence model (training completed) 840, and the artificial intelligence model (training completed) 840 may be divided into artificial intelligence models (category n-training data n). The artificial intelligence model (training not completed) 830 may be only designed for the artificial intelligence model and may be in a state in which a separate learning procedure is not performed. With respect to the artificial intelligence model (training not completed) 830, information on the artificial intelligence model and information on the training data that may be trained by being input to the artificial intelligence model may be provided.

The artificial intelligence model (training not completed) 830 may be designed for the artificial intelligence model and may then may be in a state in which the training procedure is performed by receiving the training data. With respect to the artificial intelligence model (training not completed) 830, the information on the artificial intelligence model, the information on the training data that may be trained by being input to the artificial intelligence model, and the information on artificial intelligence model performance may be provided.

The artificial intelligence model (category n-training data n) 850 is a model included in a lower part of the artificial intelligence model (training completed) 840 and may be a model trained by receiving specific training data n of category n.

For example, when there is an artificial intelligence model that determines a specific object, on the project store, the artificial intelligence model (training not completed) 830 that a user may train by inputting training data without inputting separate training data may be present. When the user device wants to train the artificial intelligence model by inputting desired training data, the user device may receive and train the artificial intelligence model (training not completed) 830 to train the artificial intelligence model according to the user's purpose.

There may be a case in which among the user devices, a user device wants to receive and utilize the pre-trained artificial intelligence model (training completed) 840. For example, when an artificial intelligence model for determining a cat on an image is required, among the artificial intelligence models (training completed) 840, an artificial intelligence model (training completed) 840 trained to be able to discriminate a cat and may be received and utilized. In this case, the artificial intelligence model provided to the user may be an artificial intelligence model (cat-cat data set 1).

The artificial intelligence model (training not completed) 830 and the artificial intelligence model (training completed) 840 may be sold to a user, and a sales amount may be distributed according to the level of contribution. In the case of the artificial intelligence model (training not completed) 830, the sales amount is distributed to a user who designs and develops the artificial intelligence model, and the artificial intelligence model (training completed) 840 may distribute the sales amount not only to a user who designs and develops the artificial intelligence model, but only to a user who provides training data for the artificial intelligence model (training completed) 840 or performs preprocessing on the training data.

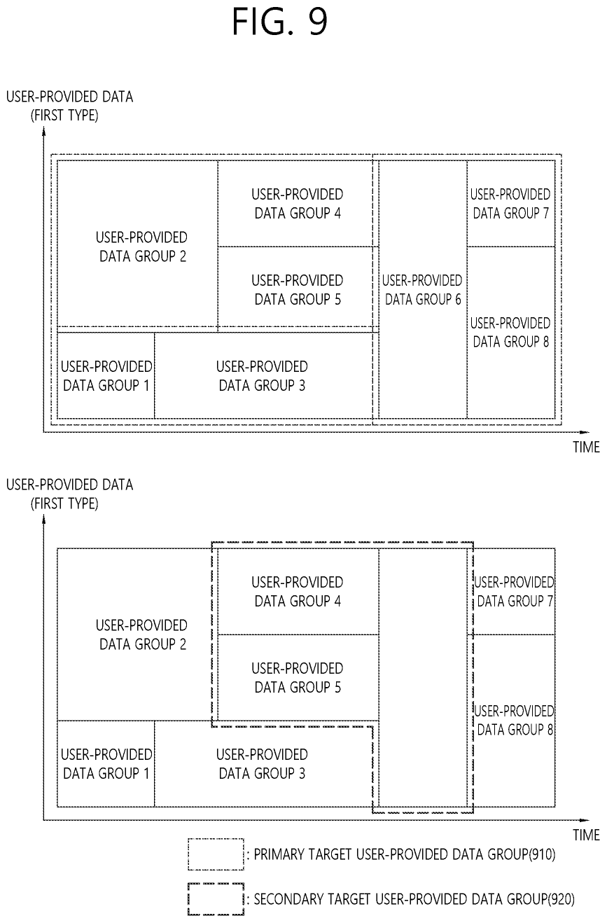

FIG. 9 is a conceptual diagram illustrating a method of providing an artificial intelligence service according to an embodiment of the present invention.

FIG. 9 is a conceptual diagram illustrating a method for utilizing user-provided data related to another project and an artificial intelligence model through a project store.

When the training on the artificial intelligence model is performed, as artificial intelligence processing data, a training loss, a reciprocal of the training loss (hereinafter referred to as the training score), information on a chart or the like that may check the training situation and the time remaining for training in real time may be provided.

When the learning effect on the artificial intelligence model is good, the training score should increase while the training loss decreases.

According to an embodiment of the present invention, a determination on a training effect may be performed using artificial intelligence processing data including a performance index for an artificial intelligence model.

As described above, when the artificial intelligence model (training not completed) is converted to the artificial intelligence model (training not completed) by selecting an artificial intelligence model (training not completed), and inputting user-provided data (first type) for training on the artificial intelligence model (training not completed), it is possible to determine the training state of the artificial intelligence model according to the input of the user-provided data (first type) on the worker server.

In order to perform this determination, the user-provided data (first type) may be classified according to the input time and data group of the user-provided data and utilized for training.

The user-provided data may be continuously input over time, and the user data continuously input over time by at least one user device may be classified into a plurality of user-provided data groups.

The user-provided data group may be a group grouped according to the characteristics of the user-provided data. For example, the user-provided data group may be user-provided data uploaded for each user device or user-provided data uploaded by a plurality of user device groups having a similar data upload tendency.

At least one user-provided data group may be selected from among the plurality of user-provided data groups, and a primary target user-provided data group 910 including at least one user-provided data group may be determined. There may be a plurality of such primary target user-provided data groups 910.

At least one primary selection artificial intelligence model having a relatively high performance index may be selected from among a plurality of artificial intelligence models trained based on each of a plurality of target user-provided data groups, and in order to train this primary selection artificial intelligence model, a secondary target user-provided data group 920 may be determined by combining the target user-provided data groups utilized to train the primary selection artificial intelligence model, and a secondary selection artificial intelligence model may be determined based on the secondary target user-provided data group 920.

In this way, it is possible to create various artificial intelligence training models according to user-provided data but create an artificial intelligence model with a high performance index. User-provided data groups may be selected and used.

Data sizes of the plurality of user-provided data groups may be classified according to the amount of utilizable user-provided data (first type). As the amount of user-provided data (first type) relatively increases, the data size of the user-provided data group may be set to be relatively large.

Alternatively, the data size of the user-provided data group may be classified according to the private project or the public project. The private project may be divided into units of user devices participating in the private project, and the public project may be divided based on the reliability of the user devices participating in the public project. The data size of the user-provided data group may be determined by being classified in units of reliability of user devices. The reliability of the user device participating in the public project may be set in consideration of the user-provided data uploaded by the user device, preprocessing accuracy, etc., or may be set as an email account or the like authorized by the project owner.

The above-described embodiments according to the present invention may be implemented in a form of program instructions that may be executed through various computer components and may be recorded on a computer-readable recording medium. The computer-readable recording medium may include program instructions, data files, data structures, or the like, alone or a combination thereof. The program instructions recorded on the computer-readable recording medium may be especially designed and constituted for the present invention or known to those skilled in the field of computer software. Examples of the computer-readable recording medium may include a magnetic medium such as a hard disk, a floppy disk, or a magnetic tape, an optical recording medium such as a compact disc read only memory (CD-ROM) or a digital versatile disc (DVD), a magneto-optical medium such as a floptical disk, and a hardware device specially configured to store and execute program instructions, such as a read only memory (ROM), a random access memory (RAM), a flash memory, or the like. Examples of the program instructions include high-level language code capable of being executed by a computer using an interpreter, or the like, as well as machine language code made by a compiler. A hardware device may be changed into one or more software modules to perform processing according to the present invention, and vice versa.

According to the present invention, it is possible to provide an artificial intelligence service platform that makes it easier for users to utilize artificial intelligence models.

In addition, according to the present invention, it is possible facilitate user's artificial intelligence model learning through an artificial intelligence service platform, and input data processing through a pre-designed artificial intelligence model.

In addition, according to the present invention, it is possible to provide multiple users with artificial intelligence services by enabling the multiple users to participate in one artificial intelligence project.

In the above, the present invention has been described with reference to specific matters such as specific components and limited embodiments and drawings, but these are only provided to help a more general understanding of the present invention, and the present invention is not limited to the above embodiments, and those of ordinary skill in the art to which the invention pertains can make various modifications and changes from these descriptions.

Therefore, the spirit of the present invention should not be limited to these exemplary embodiments, and the claims and all of modifications equal or equivalent to the claims are intended to fall within the scope and spirit of the present invention.

What is claimed is:

1. A method of providing an artificial intelligence service based on user participation, comprising:
receiving, by an artificial intelligence service platform, a request for an artificial intelligence service from a user device;
receiving, by the artificial intelligence service platform, user-provided data from the user device; and
providing, by the artificial intelligence service platform, the artificial intelligence service to the user device based on the user-provided data.

2. The method of claim 1, wherein the artificial intelligence service platform includes one or more artificial intelligence applications for the artificial intelligence service, and
each of the one or more artificial intelligence applications is created based on an artificial intelligence model.

3. The method of claim 2, wherein the artificial intelligence service platform creates a project corresponding to the user device for the artificial intelligence service, and
the user-provided data is stored in correspondence to the project.

4. An artificial intelligence service platform for providing an artificial intelligence service based on user participation, comprising:
a master server configured to receive a request for an artificial intelligence service from a user device;
a storage server configured to receive user-provided data from the user device; and
a worker server configured to provide the artificial intelligence service to the user device based on the user-provided data.

5. The artificial intelligence service platform of claim 4, wherein the artificial intelligence service platform includes one or more artificial intelligence application for the artificial intelligence service, and
each of the one or more artificial intelligence application is created based on an artificial intelligence model.

6. The artificial intelligence service platform of claim 5, wherein the storage server creates a project corresponding to the user device for the artificial intelligence service, and
the user-provided data is stored in correspondence to the project.
